(19) United States
(12) Patent Application Publication
(10) Pub. No.: US 2012/0238030 A1
(43) Pub. Date: Sep. 20, 2012

(54) Methods and Systems for Multiplex Analysis of Biomolecules by Liquir Chromatography-Mass Spectrometry

(75) Inventors: Brian Alexander Rappold, St. Louis, MO (US); Russell Philip Grant, Chapel Hill, NC (US)

(73) Assignee: LABORATORY CORPORATION OF AMERICA HOLDINGS, Burlington, NC (US)

(21) Appl. No.: 13/367,669

(22) Filed: Feb. 7, 2012

Related U.S. Application Data
(60) Provisional application No. 61/440,193, filed on Feb. 7, 2011.

(51) Int. Cl. H01J 49/26; G01N 27/62

(52) U.S. Cl. 436/89; 250/282; 250/288

(57) ABSTRACT

Multiplex analysis methods for rapid analysis of the presence or amount of two or more biomolecules in a sample are disclosed. Systems implementing such methods are further disclosed.

### CROSS-REFERENCE TO RELATED APPLICATIONS

The present application claims the benefit of priority of U.S. Provisional Patent Application No. 61/440,193, filed Feb. 7, 2011, which is incorporated by reference as though fully set forth herein.

### FIELD OF THE INVENTION

The present invention provides methods and systems for analyzing biomolecules in a sample. In particular, the invention provides methods and systems for the multiplex analysis of biomolecules in a sample using liquid chromatography and mass spectrometry.

### BACKGROUND

The identification and measurement of amino acids in the bodily fluid of a subject can provide valuable information regarding the subject's health. For example, there are many diseases and disorders that are characterized by an overabundance of or a deficiency in the amount of a particular amino acid or group of amino acids in the subject's bodily fluids. These diseases or disorders may vary widely in their cause or type, ranging from metabolic disorders to organ failures to cancer. Detection of the particular relevant amino acids can be useful for identifying a disease state and/or monitoring treatment of a disease state.

Some diseases associated with aberrant amino acid levels have been described as being inborn errors of metabolism (IEMs). These types of diseases have an overall occurrence of approximately 1 in 2,000 to 1 in 4,000 births; however, the incidence of each individual disease is much rarer. Some of these metabolic disorders are screened nationwide in newborns by law, and early diagnosis is critical to a positive prognosis for affected individuals. One example of a disease where it is important to monitor amino acid levels is phenylketonuria, a metabolic genetic disorder wherein an enzyme necessary for the metabolism of the amino acid phenylalanine is deficient. The enzyme, phenyalanine hydroxylase, may convert phenylalanine into the amino acid tyrosine. Newborns are routinely screened for phenylketonuria because, if left untreated, the disease can affect brain development, which may lead to mental retardation, brain damage, and/or seizures. The disease may be detected based on high levels of phenylalanine in the blood or urine.

Other examples of diseases and disorders specifically related to abnormal levels of amino acids may include, but are not limited to: Maple Syrup Urine disease; tyrosinemia type 1 and type 3 (Hawkinsinuria); tyrosinemia type 2 and transient tyrosinemia; carbamyl phosphate synthetase (CPS) or ornithine transcarbamylase (OTC); citrullinemia (argininosuccinate synthetase deficiency) Type 1 and 2; argininosuccinate lyase deficiency; arginemia (arginase deficiency); dihydropteridine reductase deficiency; hawkinsinuria; propionic academia; multiple carboxylase methylmalonic academia; hypervalinemia or hyperleucinemia (iso and L-); hypermethioninemeia (MAT 1 and MAT 2); ornithine transcarbamylase deficiency; N-acetylglutamate or carbamoyl phosphate synthetase deficiency; hyperornithinemia, hyperammonemia, and homocitrullinemia (HHH); ornithinemia; renal Fanconi syndrome; cystathioninuria; molybdenum cofactor defect; homocystinuria; lysinuric protein intolerance; hyperprolinemia type 1; hyperprolinemia type 2; Δ1-pyrroline-5-carboxylate synthetase deficiency; hyperhydroxyprolinemia; prolidase deficiency; hyper-β-alaninemia; hyper-β-aminoisobutyric aciduria; pyridoxine dependency with seizures; GABA-transaminase deficiency; carnosinemia, homocarnosinemia; hyperlysinemia; saccharopinuria, histidinemia; nonketotic hyperglycinemia (glycine encephalopathy); sarcosinemia; cystinuria; iminoglycinuria; and aminoacylase deficiency. These diseases may have an onset at any age, and may, in some instances, be difficult to diagnose. Physical examinations often are non-specific, and many of the IEMs share symptoms with other diseases (e.g., intercranial hemorrhages, certain hemangiomas, hepatocellular dysfunction, neonatal sepsis).

Amino acid levels also may be abnormal in patients suffering from a variety of conditions such as cancer, anorexia, arthritis, alcoholism, depression, Crohn's disease, colitis, chronic fatigue syndrome, psychosis, diabetes, liver disease, pancreatitis, vitamin deficiency, Wilson's disease, Cushing's disease, gout, heavy metal poisoning, or infectious diseases/fevers.

Therefore, measuring the levels and types of amino acids present in a subject's bodily fluids may be extremely useful for diagnosing and monitoring the treatment of multiple types of diseases. But because amino acids are complex molecules with diverse chemical structures and properties (e.g., having polar, nonpolar, and/or aromatic groups), the separation, detection, and identification of amino acids in bodily fluids presents a variety of challenges. Currently available methods for detecting amino acids include liquid chromatography (LC) or gas chromatography (GC), by which amino acids within a sample may be separated, usually coupled with mass spectrometry (MS), which measures the mass-to-charge ratio of the charged particles in a sample. The combination of techniques used together is referred to as LC-MS or GC-MS.

Traditionally, in order for amino acids to be accurately detected by LC-MS, the amino acids are first derivatized. This derivatization step requires the addition of derivatizing agents to a sample containing the amino acids, and the derivatizing agents react with the free amino groups of the amino acids in the sample. This step involves a relatively lengthy process, resulting in extra expense in detecting and measuring amino acid levels. One example of current methodology for analyzing amino acids in a sample involves ion-exchange LC (IEX-LC) analysis with post-column ninhydrin derivitization detection. Sample preparation for that method typically involves at least four steps, the performance of which can take up to an hour or more to prepare fifty samples. Using such methods, sample analysis can require as much as 150 minutes for inject to inject cycle.

Moreover, disorders associated with amino acid metabolism are detected and monitored by quantitating more than fifty amino acids. Because of the diverse characteristics of the various amino acids, the optimal separation and detection of each amino acid can require different reagents and separation mechanisms. Therefore, in order to analyze the amino acids with high accuracy, multiple tests would need to be run for each sample. The need for multiple tests requires larger sample volumes to be obtained from the subject, which presents problems, for example, in newborn subjects. The need for multiple tests also results in additional time required before results are available, for example, to a physician and/or a subject.

Thus, there is a continuing need for improved methods and systems for detecting, analyzing, and quantifying amino acids in a sample, e.g., a biological sample, so as to allow for the screening of multiple disorders from a single sample in a single analytical run, thereby allowing diseases and conditions associated with aberrant amino acid levels to be diagnosed efficiently and at a reasonable cost.

### SUMMARY OF THE INVENTION

In at least one aspect, the invention provides methods for analyzing the presence or amount of two or more biomolecules in a sample, the methods comprising: (a) providing a sample comprising a first biomolecule and a second biomolecule; (b1) chromatographically separating the first biomolecule from other components in the sample using a first liquid chromatography column, and (b2) chromatographically separating the second biomolecule from other components in the sample using a second liquid chromatography column; wherein the first liquid chromatography column and the second liquid chromatography column employ different column chemistries; and (c) analyzing the chromatographically separated first biomolecule and the chromatographically separated second biomolecule by mass spectrometry to determine the presence or amount of the first biomolecule and the second biomolecule in the sample. Further embodiments of these methods are described in detail below. For example, in some embodiments, the methods may employ more than two liquid chromatography columns and may analyze more than two different biomolecules.

In another aspect, the invention provides methods for analyzing the amount of two or more amino acids in a biological sample, the methods comprising: (a) providing a sample, the sample comprising a biological sample that contains a first amino acid and a second amino acid; (b) deproteinating the sample; (c1) chromatographically separating the first amino acid from other components in the sample using a first liquid chromatography column, and (c2) chromatographically separating the second amino acid from other components in the sample using a second liquid chromatography column, wherein the first liquid chromatography column and the second liquid chromatography column employ different column chemistries; and (d) analyzing the chromatographically separated first amino acid and the chromatographically separated second amino acid by mass spectrometry to determine the amount of the first amino acid and the second amino acid in the sample. Further embodiments of these methods are described in detail below. For example, in some embodiments, the methods may employ more than two liquid chromatography columns and may analyze more than two different biomolecules.

In another aspect, the invention provides methods for generating a report for diagnosing a disease or condition associated with an abnormal level of a biomolecule in a subject, the methods comprising: (a) providing a sample, the sample comprising a biological sample that contains a first biomolecule and a second biomolecule; (b) deproteinating the sample; (c1) chromatographically separating the first biomolecule from other components in the biological sample using a first liquid chromatography column, and (c2) chromatographically separating the second biomolecule from other components in the sample using a second liquid chromatography column, wherein the first liquid chromatography column and the second liquid chromatography column employ different column chemistries; (d) analyzing the chromatographically separated first biomolecule and the chromatographically separated second biomolecule by mass spectrometry to determine the amount of the first biomolecule and the second biomolecule in the sample; and (e) generating a report that recites the concentration of at least one of the first biomolecule or the second biomolecule in the biological sample. Further embodiments of these methods are described in detail below. For example, in some embodiments, the methods may employ more than two liquid chromatography columns and may analyze more than two different biomolecules.

In another aspect, the invention provides systems for analyzing of two or more biomolecules in a sample, the systems comprising: (a) a sample, the sample comprising a first biomolecule and a second biomolecule; (b) a station for chromatographically separating the first biomolecule from other components in the sample using a first liquid chromatography column, and for separating the second biomolecule from other components in the sample using a second liquid chromatography column, wherein the first liquid chromatography column and the second liquid chromatography column employ different column chemistries; and (c) a station for analyzing the chromatographically separated first biomolecule and the chromatographically separated second biomolecule by mass spectrometry to determine the presence or amount of the first biomolecule and the second biomolecule in the sample. Further embodiments of these systems are described in detail below. For example, in some embodiments, the systems may employ more than two liquid chromatography columns and may be designed to analyze more than two different biomolecules.

Further aspects of the present invention are described in the Detailed Description and in the Claims.

### BRIEF DESCRIPTION OF THE DRAWINGS

The present application includes the following figures. The figures are intended to illustrate certain embodiments and/or features of the invention, and to supplement any description(s) of the invention. The figures do not limit the scope of the invention, unless the written description expressly indicates that such is the case.

FIGS. 1A and 1B are tables showing the normal range obtained using a method of the present invention for each of the amino acids analyzed in plasma samples that were obtained from normal individuals. The age ranges of the individuals in FIG. 1A are less than 1 month and 1-2 years. The age ranges of the individuals in FIG. 1B are 1-16 years, 2-16 years, and greater than 16 years of age. The lower and upper concentration for each amino acid listed is shown as micromoles/L of plasma. 1-MHis and 3-MHis are 1-methyl histidine and 3-methyl histidine, respectively. GABA is gamma-aminobutyric acid.

FIG. 2 is a table showing the normal range obtained using a method of the invention for each of the amino acids analyzed in cerebrospinal fluid samples that were obtained from normal individuals. The age range of the individuals is less than 1 month, 1 month-1 year, 1-18 years, and greater than 18 years of age. The lower and upper concentration for each amino acid listed is shown as micromoles/L of cerebrospinal fluid. 1-MHis and 3-MHis are 1-methyl histidine and 3-methyl histidine, respectively. GABA is gamma-aminobutyric acid.

FIGS. 3A, 3B, and 3C are tables showing the normal range obtained using a method of the invention for each of the amino acids analyzed in urine samples that were obtained from normal individuals. The age ranges of the individuals in FIG. 3A are less than 1 month, 1 month-2 years, and 2-12 years. The age ranges of the individuals in FIG. 3B are 12-18 years, and greater than 18 years of age. The age ranges of the individuals in FIG. 3C are 3-12 years, and greater than 12 years analyzed by gender as well as a whole group. The lower and upper concentration for each amino acid listed in FIGS. 3A and 3B are shown as micromoles/gram creatinine. The lower and upper concentration for each amino acid listed in FIG. 3C is shown as micromoles/24 hours. 1-MHis and 3-MHis are 1-methyl histidine and 3-methyl histidine, respectively. GABA is gamma-aminobutyric acid.

FIG. 4 is an example of the type of results that are obtained using a multiplex method of the invention for analyzing amino acids in a biological sample. The sample analysis time is shown below the chromatograms in minutes. RP#1 and RP#2 indicate that reverse phase columns were used for the separation step, and HILIC indicates that a hydrophilic interaction liquid chromatography column was used for the separation step.

### DETAILED DESCRIPTION

The following description recites various aspects and embodiments of the present invention. No particular embodiment is intended to define the scope of the invention. Rather, the embodiments merely provide non-limiting examples various methods and systems that are at least included within the scope of the invention. The description is to be read from the perspective of one of ordinary skill in the art; therefore, information well known to the skilled artisan is not necessarily included.

### DEFINITION AND ABBREVIATIONS

The following terms, unless otherwise indicated, shall be understood to have the following meanings:

As used herein, the terms “a,” “an,” and “the” can refer to one or more unless specifically noted otherwise.

As used herein, the term “amino acid” refers broadly to carboxylic acid compounds that have an amine group attached to a proximate carbon atom that is proximate to the carbon to which the carboxyl group is attached, e.g., alpha, beta, or gamma. Thus, the term includes the twenty traditional amino acids, isomers thereof, and L- or D-amino acids thereof. As used herein, “amino acid” also refers to derivatives of the twenty traditional amino acids. For example, as used herein, the term “amino acid” includes, but is not limited to 1-methylhistidine, 3-methylhistidine, α-aminoadipic acid, α-amino-n-butyric acid, alanine, alloisoleucine, α-acetyl lysine, anserine, arginine, argininosuccinic acid, asparagine, β-alanine, β-aminoisobutyric acid, aspartic acid, β-aspartylglucosamine, carnosine, citrulline, cystathionine, cysteine-homocysteine, cysteine, δ-aminolevulinic acid, ε-acetyl lysine, ethanolamine, formiminoglutamic acid, γ-amino-n-butyric acid, γ-carboxyglutamic acid, glutamic acid, glutamine, glycine, glycine-glycine, glycine-proline, hawkinsin, histidine, homocarnosine, homocitrulline, homocysteine, homoserine, hydroxylysine, hydroxy-proline, isoleucine, leucine, lysine, methionine, O-phosphoserine, ornithine, phenylalanine, phosphoethanolamine, pipecolic acid, proline, proline-hydroxyproline, pyrroline-5-carboxylate, saccharopine, S-adenosyl-homocysteine, S-adenosyl-methionine, sarcosine, serine, S-sulfo-cysteine, taurine, threonine, tryptophan, tyrosine, valine, L-DOPA, 3-nitrotyrosine, 3-iodo-tyrosine, 5-oxoproline, n-acetyl lysine, and hydroxyarginine.

As used herein, the term “biomolecule” includes, but is not limited to, biological molecules such as amino acids, fatty acids, peptides, and polypeptides or proteins. The term “biomolecule” also refers to various compounds commonly present in mammalian species, such as orotic acid, succinyl acetone, putrescine, spermidine, spermine, serotonin, dopamine, vanillyl mandelic acid, homovanillic acid, and 5-hydroxyindole acetic acid.

Throughout this application, the term “about” is used to indicate that a value includes the inherent variation of error for the device, the method being employed to determine the value, or the variation that exists among the study subjects.

As used herein, the terms “subject,” “individual,” and “patient” are used interchangeably. The use of these terms does not imply any kind of relationship to a medical professional, such as a physician.

The term “deproteinating” is used herein to refer to the removal of protein from a biological sample.

As used herein the term “biological sample” is used to refer to any fluid or tissue that can be isolated from an individual. For example, a biological sample may be whole blood, plasma, serum, other blood fraction, urine, cerebrospinal fluid, tissue homogenate, saliva, amniotic fluid, bile, mucus, peritoneal fluid, lymphatic fluid, perspiration, tissues, tissue homogenate, and the like.

As used herein, the phrase “liquid chromatography” or “LC” is used to refer to a process for the separation of one or more molecules or analytes in a sample from other analytes in the sample. LC involves the slowing of one or more analytes of a fluid solution as the fluid uniformly moves through a column of a finely divided substance. The slowing results from the distribution of the components of the mixture between one or more stationery phases and the mobile phase. LC includes, for example, reverse phase liquid chromatography (RPLC) and high pressure liquid chromatography (HPLC).

As used herein, the term “separate” or “purify” or the like are not used necessarily to refer to the removal of all materials other than the analyte of interest from a sample matrix. Instead, in some embodiments, the terms are used to refer to a procedure that enriches the amount of one or more analytes of interest relative to one or more other components present in the sample matrix. In some embodiments, a “separation” or “purification” may be used to remove or decrease the amount of one or more components from a sample that could interfere with the detection of the analyte, for example, by mass spectrometry.

As used herein, the term “mass spectrometry” or “MS” analysis refers to a technique for the identification and/or quantitation of molecules in a sample. MS includes ionizing the molecules in a sample, forming charged molecules; separating the charged molecules according to their mass-to-charge ratio; and detecting the charged molecules. MS allows for both the qualitative and quantitative detection of molecules in a sample. The molecules may be ionized and detected by any suitable means known to one of skill in the art. The phrase “tandem mass spectrometry” or “MS/MS” is used herein to refer to a technique for the identification and/or quantitation of molecules in a sample, wherein multiple rounds of mass spectrometry occur, either simultaneously using more than one mass analyzer or sequentially using a single mass analyzer. As used herein, a “mass spectrometer” is an apparatus that includes a means for ionizing molecules and detecting charged molecules.

As used herein, “electrospray ionization” or “ESI” refers to a technique used in mass spectrometry to ionize molecules in a sample while avoiding fragmentation of the molecules. The sample is dispersed by the electrospray into a fine aerosol. The sample will typically be mixed with a solvent, usually a volatile organic compound (e.g., methanol or acetonitrile) mixed with water. The aerosol is then transferred to the mass spectrometer through a capillary, which can be heated to aid further solvent evaporation from the charged droplets.

As used herein, a “quadrupole analyzer” is a type of mass analyzer used in MS. It consists of four circular rods (two pairs) that are set highly parallel to each other. The quadrupole analyzer is the component of the instrument that organizes the charged particles of the sample based on their mass-to-charge ratio. One of skill in the art would understand that use of a quadrupole analyzer can lead to increased specificity of results. One pair of rods is set at a positive electrical potential and the other set of rods is at a negative potential. To be detected, an ion must pass through the center of a trajectory path bordered and parallel to the aligned rods. When the quads are operated at a given amplitude of direct current and radio frequency voltages, only ions of a given mass-to-charge ratio will resonate and have a stable trajectory to pass through the quadrupole and be detected. As used herein, “positive ion mode” refers to a mode wherein positively charged ions are detected by the mass analyzer, and “negative ion mode” refers to a mode wherein negatively charged ions are detected by the mass analyzer. For “selected ion monitoring” or “SIM,” the amplitude of the direct current and the radio frequency voltages are set to observe only a specific mass.

### Methods for Analyzing Biomolecules

In at least one aspect, the invention provides methods for analyzing the presence or amount of two or more biomolecules in a sample, the methods comprising: (a) providing a sample comprising a first biomolecule and a second biomolecule; (b1) chromatographically separating the first biomolecule from other components in the sample using a first liquid chromatography (LC) column, and (b2) chromatographically separating the second biomolecule from other components in the sample using a second liquid chromatography (LC) column; wherein the first liquid chromatography column and the second liquid chromatography column employ different column chemistries; and (c) analyzing the chromatographically separated first biomolecule and the chromatographically separated second biomolecule by mass spectrometry to determine the presence or amount of the first biomolecule and the second biomolecule in the sample.

Such methods are not limited to the use of only two LC columns in parallel. In some embodiments, the methods employ three or more, four or more, five or more, six or more, eight or more, ten or more, or twelve or more LC columns in parallel. In some such embodiments, the methods employ three, or four, or five, or six, or seven, or eight, or ten, or twelve LC columns in parallel.

Further, such methods are not limited to the analysis of only two biomolecules. In some embodiments, the methods include analysis of three or more, four or more, five or more, six or more, eight or more, ten or more, or twelve or more different biomolecules. In some such embodiments, the methods include analysis of three, or four, or five, or six, or seven, or eight, or ten, or twelve different biomolecules.

For example, in some embodiments, the invention provides methods for analyzing the presence or amount of two or more biomolecules in a sample, the methods comprising: (a) providing a sample comprising a first biomolecule, a second biomolecule, and at least one additional biomolecule (e.g., a third, fourth, fifth biomolecule, etc.); (b1) chromatographically separating the first biomolecule from other components in the sample using a first liquid chromatography column, (b2) chromatographically separating the second biomolecule from other components in the sample using a second liquid chromatography column, and (b3) chromatographically separating each of the additional biomolecules from other components in the sample using at least one additional liquid chromatography column; wherein the first liquid chromatography column, the second liquid chromatography column, and one or more of the at least one or more liquid chromatography columns each can have different column chemistries; and (c) analyzing the chromatographically separated first biomolecule, the chromatographically separated second biomolecule, and the chromatographically separated one or more additional biomolecules by mass spectrometry to determine the presence or amount of the first biomolecule, the second biomolecule, and the one or more additional biomolecules in the sample.

These methods may be used to analyze the presence or amount of two or more biomolecules in a sample. In some embodiments, the methods are use to analyze the presence of one or more biomolecules. In some embodiments, the methods are use to analyze the amount of one or more biomolecules. In some embodiments, the methods are used to analyze the presence of one or more biomolecules and analyze the amount of one or more biomolecules.

These methods comprise providing a sample comprising two or more biomolecules. In this context, the term “providing” is to be construed broadly. The term is not intended to refer exclusively to a subject who provided a biological sample. For example, a technician in an off-site clinical laboratory can be said to “provide” the sample, for example, as the sample is prepared for introduction to the two or more LC columns.

The two or more biomolecules can include a wide array of biomolecules (as defined above). In some embodiments, at least one of the two or more biomolecules is an amino acid (as defined above). In some such embodiments, at least two of the two or more biomolecules is an amino acid (as defined above). In some embodiments, such amino acids independently are: 1-methylhistidine, 3-methylhistidine, α-aminoadipic acid, α-amino-n-butyric acid, alanine, alloisoleucine, α-acetyl lysine, anserine, arginine, argininosuccinic acid, asparagine, β-alanine, β-aminoisobutyric acid, aspartic acid, β-aspartylglucosamine, carnosine, citrulline, cystathionine, cysteine-homocysteine, cysteine, δ-aminolevulinic acid, ε-acetyl lysine, ethanolamine, formiminoglutamic acid, γ-amino-n-butyric acid, γ-carboxyglutamic acid, glutamic acid, glutamine, glycine, glycine-glycine, glycine-proline, hawkinsin, histidine, homocarnosine, homocitrulline, homocysteine, homoserine, hydroxylysine, hydroxy-proline, isoleucine, leucine, lysine, methionine, O-phosphoserine, ornithine, phenylalanine, phosphoethanolamine, pipecolic acid, proline, proline-hydroxyproline, pyrroline-5-carboxylate, saccharopine, S-adenosyl-homocysteine, S-adenosyl-methionine, sarcosine, serine, S-sulfo-cysteine, taurine, threonine, tryptophan, tyrosine, valine, L-DOPA, 3-nitrotyrosine, 3-iodo-tyrosine, 5-oxoproline, n-acetyl lysine, or hydroxyarginine.

The invention is not limited to any particular sample size. In some embodiments, the sample comprises a biological sample. In such embodiments, the sample may also include other components, such as solvents, buffers, anticlotting agents and the like. In embodiments where the sample comprises a biological sample, the biological sample can be one or more of whole blood, plasma, serum, urine, cerebrospinal fluid, tissue homogenate, saliva, amniotic fluid, bile, mucus, peritoneal fluid, or lymphatic fluid. The invention is not limited to any particular volume of biological sample. In some embodiments, the biological sample is at least about 25-250 μL, at least about 35-200 μL, at least about 45-150 μL, or at least about 50-100 μL, in volume. In certain embodiments, the biological sample is at least about 60 μL, in volume.

In some embodiments, for example, in embodiments where the methods are used to analyze amino acids, the method can include additional processing steps to facilitate separation and analysis of the analytes of interest. Such processing methods are well known to those of skill in the art, and include, but are not limited to, centrifugation, filtration, purification, and the like. In some embodiments, the methods include deproteining the sample. Such deproteining can be carried out by any suitable method known to those of skill in the art. For example, in some embodiments, the deproteinating may comprise: combining (i) the biological sample with a deproteinating composition comprising an organic solvent, precipitating agent, or combination thereof; (ii) mixing the combined sample; and (iii) subjecting the sample to centrifugation. The precipitating agent can be one or more of methanol, ethanol, acetonitrile, a salt, or an acid. In some embodiments, the deproteinating composition comprises acetonitrile and methanol. The sample and deproteinating composition may be mixed, for example, by vortexing or using other methods known to one of skill in the art.

The invention is not limited to any particular means of sample handling or preparation. In some embodiments, it may be useful to separate the sample into two or more fractions prior to the chromatographic separation steps. In some such embodiments, two or more of such fractions may be prepared differently, for example, to help improve the sensitivity or selectivity of the separation for a particular column chemistry. In some embodiments, the method includes preparing a single sample for repeat injections across multiple liquid chromatography systems.

Methods of the invention, can, in some embodiments, include the introduction of an internal standard into one or more of the solutions introduced to LC columns. In embodiments where the methods include analysis of one or more amino acids, such internal standards can include known amounts or concentrations of two or more amino acids. In some such embodiments, the internal standard includes known amounts or concentrations of ten or more amino acids. In some such embodiments, the internal standard includes known amounts or concentrations of 2-55 amino acids. In some embodiments, the internal standard may includes at least 2, 5, 15, 20, 25, 30, 35, 40, 45, 50, 55, or 58 amino acids. In any of these embodiments, one or more of the amino acids included in the internal standard can be stably labeled, for example, with an isotope, such as carbon-13 and/or deuterium. Such amino acids may be labeled with more than two stable isotopes.

Methods of the invention may further comprise chromatographically separating the two or more biomolecules in two or more LC columns. In some embodiments, two or more of the two or more LC columns employ different column chemistries. As used herein, the term “column chemistry” refers collectively to the chemical features of the stationary phase and mobile phase used in a column. For example, a hydrophilic interaction liquid chromatography (HILIC) column employs a different column chemistry than that employed by a reverse phase column. In addition, two reverse phase columns employ different column chemistries if their stationary phases differed, such as with a C-18 column versus a C-8 column. The same would be true for two different types of HILIC columns, such as cyano versus amide. Column chemistries are also said to vary if different mobile phases are employed in columns with the same stationary phase. Thus, by using different column chemistries in two or more columns in parallel, the two or more biomolecules in the sample elute differently through each column. Thus, in some embodiments, each of the two or more LC columns uses a solvent and separation mechanism that is appropriate for separation of one or more of the biomolecules in the sample.

In some embodiments of the method, the chromatographically separating may comprise: dividing a sample into three or more fractions; introducing the three or more fractions to three or more liquid chromatography (LC) columns, each having a different column chemistry; and eluting the two or more biomolecules from the three LC columns.

The invention is not limited to any particular types of LC columns. Any suitable combination of LC columns can be used. Suitable columns include, but are not limited to reverse phase columns (e.g., C-18, C-8, fluorinated, and the like) and HILIC columns (e.g., cyano, amide, silica, and the like). In some embodiments, the method employs at least one HILIC column and at least one reverse phase column. In other embodiments, the method employs at least one HILIC column and at least two reverse phase columns.

The invention is also not limited to any particular combination of solvents for the mobile phase, although the selection of mobile phase should be suitable for use in combination with a selected LC column. Selection of suitable mobile phase compositions is within the ability of the skilled artisan. In some embodiments, the sample can be combined with one or more solvents to increase the sensitivity or selectivity of the separation. Suitable solvents for increasing sensitivity or selectivity include, but are not limited to, ethyl acetate, toluene, acetone, hexane, and tetrahydrofuran. In some embodiments, the solvent is ethyl acetate.

Because the two or more LC columns are in parallel, the chromatographic separations in different LC columns can be carried out during time intervals that overlap at least in part. The invention does not require overlapping time intervals. But overlapping time intervals can be used to reduce the time required to analyze multiple biomolecules.

The methods comprise analyzing the two or more chromatographically separated biomolecules by mass spectrometry to determine the presence or amount of the biomolecules. In some embodiments, two or more of the LC columns feed into the same mass spectrometer. In some further embodiments, three or more of the LC columns feed into the same mass spectrometer. In some embodiments, the mass spectrometer is part of a combined LC-MS system.

The invention is not limited to any particular type of mass spectrometer. Any suitable mass spectrometer can be used. In some embodiments, the method employs a tandem mass spectrometer. In some such embodiments, analyzing a biomolecule can include, ionizing the biomolecule, analyzing the ionized biomolecule, fragmenting the biomolecule into two or more fragment ions, and analyzing the fragment ions. The invention is not limited to a mass spectrometer using any particular ionization methods. Any suitable ionization can be used. Suitable ionization methods include, but are not limited to photoionization, electrospray ionization, atmospheric pressure chemical ionization, and electron capture ionization. And in embodiments that employ fragmenting, any suitable fragmentation technique can be used. Suitable techniques include, but are not limited to collision induced dissociation, electron capture dissociation, electron transfer dissociation, infrared multiphoton dissociation, radiative dissociation, electron-detachment dissociation, and surface-induced dissociation.

In some embodiments, the tandem mass spectrometer is a MDS-Sciex API5000 triple quadrupole mass spectrometer. In some embodiments, the tandem mass spectrometer has an atmospheric pressure ionization source, and the analyzing step comprises an ionization method selected from the group consisting of photoionization, electrospray ionization (ESI), atmospheric pressure chemical ionization (APCI), electron capture ionization, electron ionization, fast atom bombardment/liquid secondary ionization (FAB/LSI), matrix assisted laser desorption ionization (MALDI), field ionization, field desorption, thermospray/plasmaspray ionization, and particle beam ionization. The ionization method may be in positive ion mode or negative ion mode. The analyzing step may also include multiple reaction monitoring or selected ion monitoring (SIM), and the two or more biomolecules are analyzed simultaneously or sequentially. In some embodiments, the analyzing step uses a quadrupole analyzer.

In some embodiments, the amount of each of the two or more biomolecules need not be determined. In some embodiments, the method can be used to determine the presence or absence of one or more of the two or more biomolecules.

In other embodiments, the amount of each of the two or more biomolecules is determined. For example, in certain aspects, the invention provides methods for analyzing the amount of two or more amino acids in a biological sample, the methods comprising: (a) providing a sample, the sample comprising a biological sample that contains a first amino acid and a second amino acid; (b) deproteinating the sample; (c1) chromatographically separating the first amino acid from other components in the sample using a first liquid chromatography column, and (c2) chromatographically separating the second amino acid from other components in the sample using a second liquid chromatography column, wherein the first liquid chromatography column and the second liquid chromatography column employ different column chemistries; and (d) analyzing the chromatographically separated first amino acid and the chromatographically separated second amino acid by mass spectrometry to determine the amount of the first amino acid and the second amino acid in the sample. Further embodiments of these methods are described in detail below. For example, in some embodiments, the methods may employ more than two liquid chromatography columns and may analyze more than two different biomolecules.

### Methods of Generating Reports

In at least one aspect, the invention provides methods for generating a report for diagnosing a disease or condition associated with an abnormal level of an amino acid in a subject, the methods comprising: (a) providing a sample, the sample comprising a biological sample that contains a first amino acid and a second amino acid; (b) deproteinating the sample; (c1) chromatographically separating the first amino acid from other components in the biological sample using a first liquid chromatography column, and (c2) chromatographically separating the second amino acid from other components in the sample using a second liquid chromatography column, wherein the first liquid chromatography column and the second liquid chromatography column employ different column chemistries; (d) analyzing the chromatographically separated first amino acid and the chromatographically separated second amino acid by mass spectrometry to determine the amount of the first amino acid and the second amino acid in the sample; and (e) generating a report that recites the concentration of at least one of the first amino acid or the second amino acid in the biological sample.

The features and embodiments of all steps except step (e) are described immediately above. As noted above, the method employs at least two columns, but, in some embodiments, can employ more than two. Also, the method includes analysis of two or more biomolecules, but, in some embodiments, more than two biomolecules are analyzed.

The method further includes generating a report that recites the amount of at least one of the biomolecules in the sample. In some embodiments, this information can be used to determine the concentration of one or more biomolecules (e.g., amino acids) in a biological sample. From such information, one could assess whether a subject has an abnormally high or low amount of one or more amino acids. Amino acids analyzed as part of making such determinations include: 1-methylhistidine, 3-methylhistidine, α-aminoadipic acid, α-amino-n-butyric acid, alanine, alloisoleucine, α-acetyl lysine, anserine, arginine, argininosuccinic acid, asparagine, β-alanine, β-aminoisobutyric acid, aspartic acid, β-aspartylglucosamine, carnosine, citrulline, cystathionine, cysteine-homocysteine, cysteine, δ-aminolevulinic acid, ε-acetyl lysine, ethanolamine, formiminoglutamic acid, γ-amino-n-butyric acid, γ-carboxyglutamic acid, glutamic acid, glutamine, glycine, glycine-glycine, glycine-proline, hawkinsin, histidine, homocarnosine, homocitrulline, homocysteine, homoserine, hydroxylysine, hydroxy-proline, isoleucine, leucine, lysine, methionine, O-phosphoserine, ornithine, phenylalanine, phosphoethanolamine, pipecolic acid, proline, proline-hydroxyproline, pyrroline-5-carboxylate, saccharopine, S-adenosyl-homocysteine, S-adenosyl-methionine, sarcosine, serine, S-sulfo-cysteine, taurine, threonine, tryptophan, tyrosine, valine, L-DOPA, 3-nitrotyrosine, 3-iodo-tyrosine, 5-oxoproline, n-acetyl lysine, or hydroxyarginine.

Such information can be useful for diagnosing one or more diseases or disorders that may be associated with aberrant levels of amino acids in a subject. Such diseases or disorders include, but are not limited to: phenylketonuria, maple syrup urine disease, tyrosinemia type 1 and type 3, hawkinsinuria, tyrosinemia type 2, transient tyrosinemia, carbamyl phosphate synthetase (CPS, ornithine transcarbamylase (OTC), citrullinemia (argininosuccinate synthetase deficiency) type 1 and 2, argininosuccinate lyase deficiency, arginemia (arginase deficiency), dihydropteridine reductase deficiency, propionic academia, mulitiple carboxylase methylmalonic academia, hypervalinemia or hyperleucinemia (iso and L-), hypermethioninemeia (MAT 1 and MAT 2), ornithine transcarbamylase deficiency, N-acetylglutamate, carbamoyl phosphate synthetase deficiency, hyperornithinemia, hyperammonemia, homocitrullinemia, ornithinemia, renal Fanconi syndrome, cystathioninuria, molybdenum cofactor defect, homocystinuria, lysinuric protein intolerance, hyperprolinemia type 1, hyperprolinemia type 2, Δ1-pyrroline-5-carboxylate synthetase deficiency, hyperhydroxyprolinemia; prolidase deficiency, hyper-β-alaninemia, hyper-β-aminoisobutyric aciduria, pyridoxine dependency with seizures, GABA-transaminase deficiency, carnosinemia, homocarnosinemia, hyperlysinemia, saccharopinuria, histidinemia, nonketotic hyperglycinemia (glycine encephalopathy), sarcosinemia, cystinuria, iminoglycinuria, and aminoacylase deficiency.

### Systems for Analyzing Biomolecules

In another aspect, the invention provides systems for analyzing of two or more biomolecules in a sample, the systems comprising: (a) a sample, the sample comprising a first biomolecule and a second biomolecule; (b) a station for chromatographically separating the first biomolecule from other components in the sample using a first liquid chromatography column, and for separating the second biomolecule from other components in the sample using a second liquid chromatography column, wherein the first liquid chromatography column and the second liquid chromatography column employ different column chemistries; and (c) a station for analyzing the chromatographically separated first biomolecule and the chromatographically separated second biomolecule by mass spectrometry to determine the presence or amount of the first biomolecule and the second biomolecule in the sample.

Such systems can include various embodiments and subembodiments analogous to those described above for methods of analyzing biomolecules.

These systems include various stations. As used herein, the term “station” is broadly defined and includes any suitable apparatus or collections of apparatuses suitable for carrying out the recited method. The stations need not be integrally connected or situated with respect to each other in any particular way. The invention includes any suitable arrangements of the stations with respect to each other. For example, the stations need not even be in the same room. But in some embodiments, the stations are connected to each other in an integral unit.

It should be understood that the foregoing relates to certain embodiments of the invention and that numerous changes may be made therein without departing from the scope of the invention. The invention is further illustrated by the following examples, which are not to be construed in any way as imposing limitations upon the scope thereof. On the contrary, it is to be clearly understood that resort may be had to various other embodiments, modifications, and equivalents thereof, which, after reading the description herein may suggest themselves to those skilled in the art without departing from the spirit of the present invention and/or the scope the appended claims.

### EXAMPLES

The present invention may be better understood by reference to the following non-limiting examples.

### Example 1

### Analysis of Amino Acids in Various Biological Samples

Amino acids were measured by mass spectrometric detection after sample dilution. Analysis was performed using multiplexed liquid chromatographic analysis with tandem mass spectrometric detection (LC-MS/MS). Stably labeled isotopes (e.g., deuterium) of amino acids were added for selected amino acids to sample aliquots as internal standards.

Samples were first mixed with stable-labeled isotopic amino acids, and proteins were precipitated. Samples were then vigorously mixed and centrifuged, and the supernatant was transferred to a well of a 96 well plate. Samples were injected onto three discrete chromatographic separations into the mass spectrometer. An MDS-Sciex API5000 triple quadrupole mass spectrometer, operating in positive ion electrospray (ESI) mode was used for detection. Measurement of analyte and internal standard were performed in selected reaction monitoring mode (SRM). The back-calculated amount of amino acids in each sample was determined from calibration curves generated by spiking known amounts of purified amino acids into blank solution at a range of 0.1 to 5000 micromoles per liter, dependent on the particular amino acid being measured. Certain amino acids were measured for qualitative purposes, as clinical evaluation is based on the presence of the analyte as opposed to concentration (e.g. saccharopine).

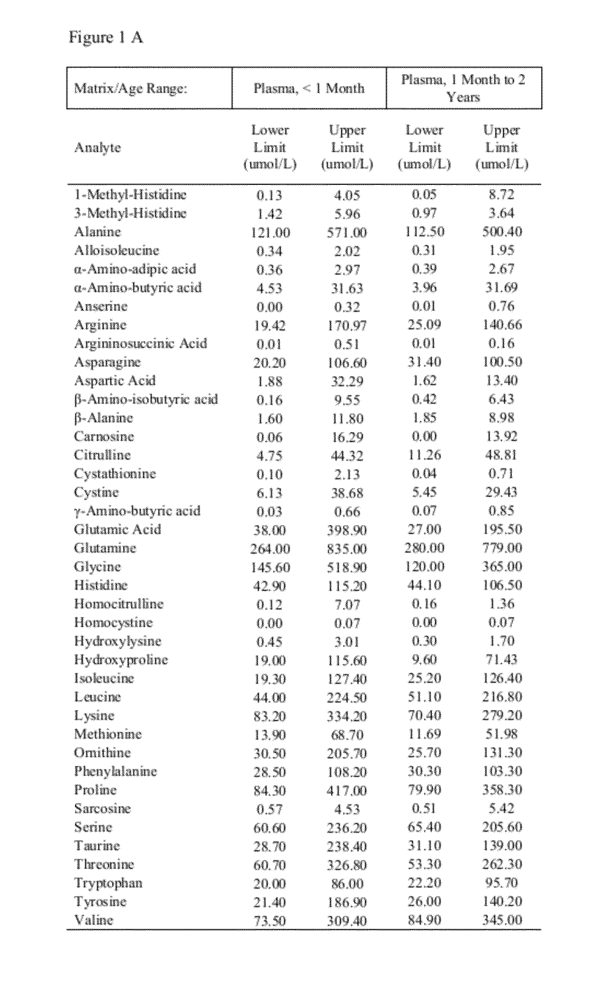

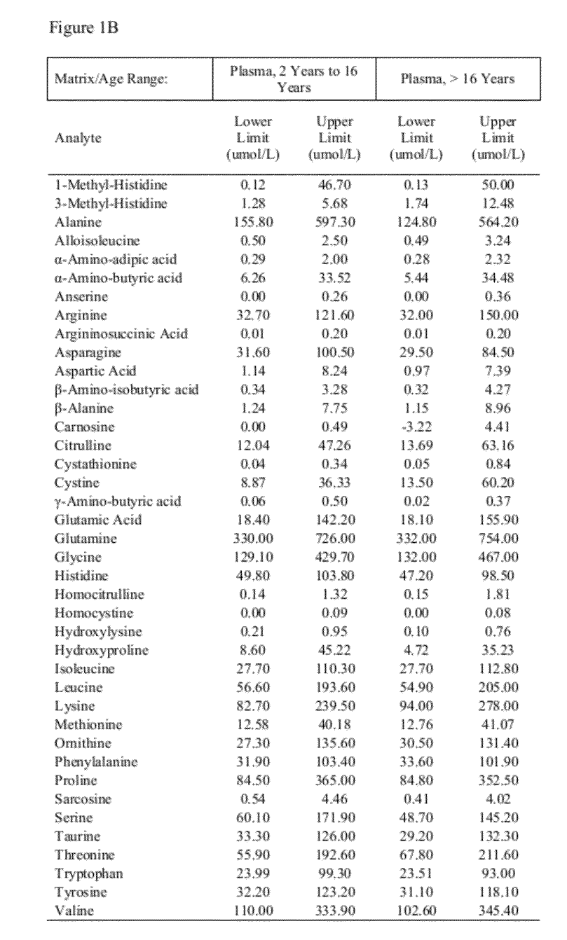

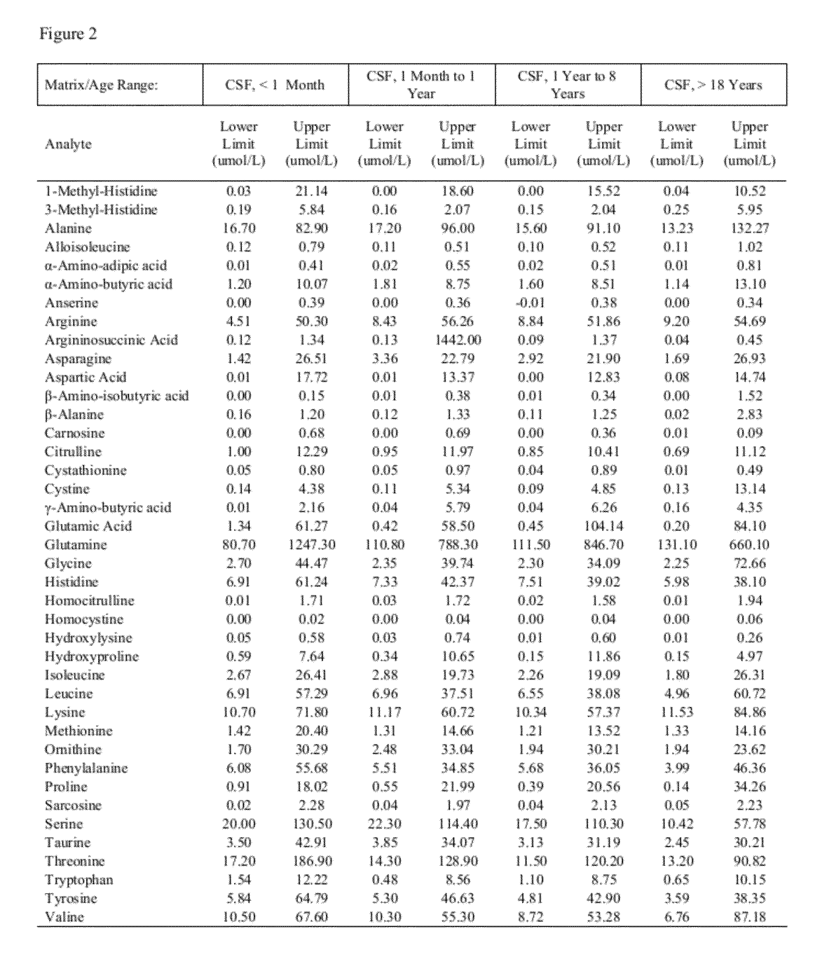

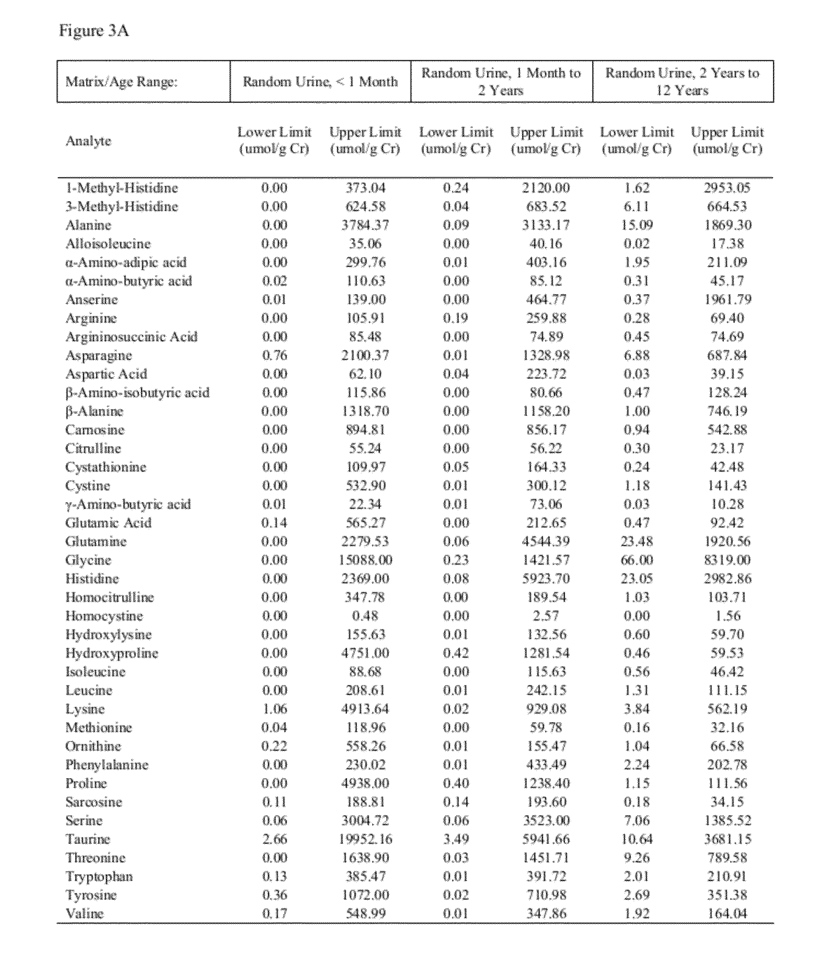

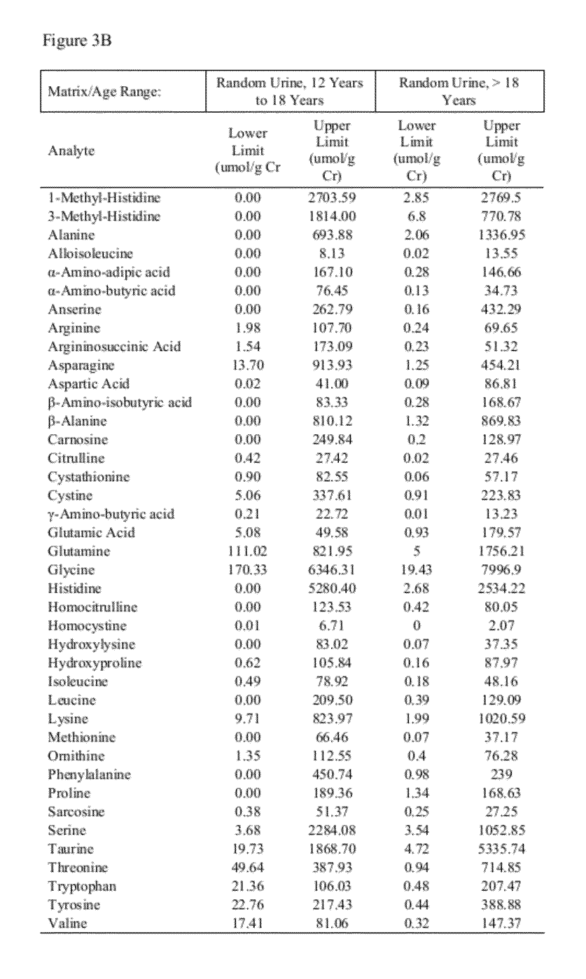

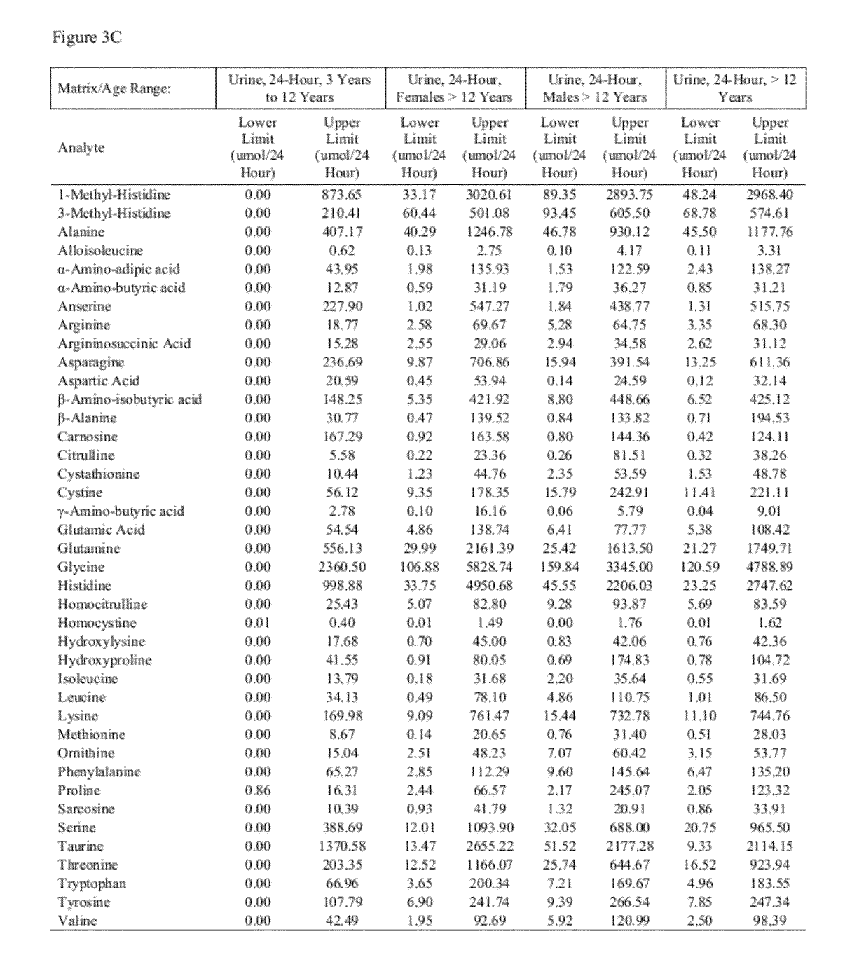

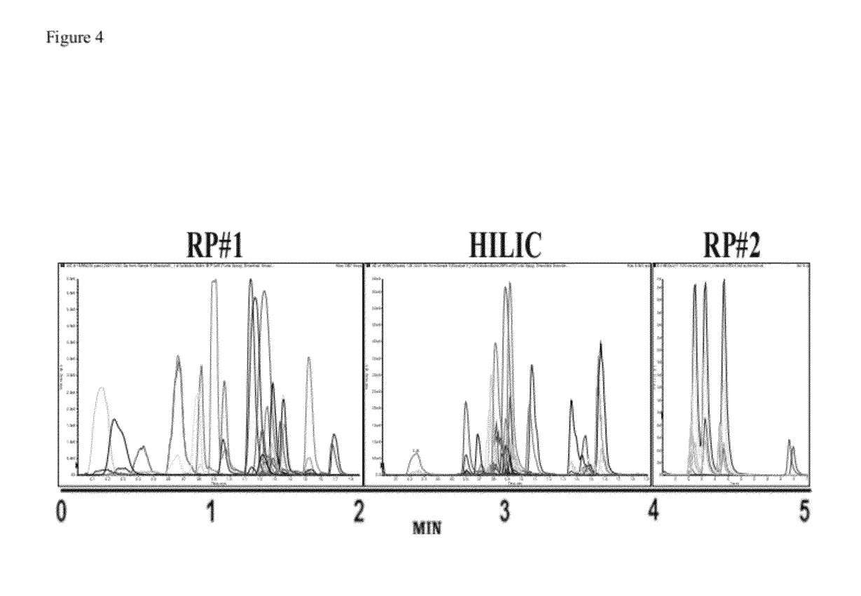

The results of such methods using different matrices (i.e., plasma, cerebrospinal fluid, and urine) from normal individuals are shown in FIGS. 1 to 3. FIGS. 1A and 1B are tables showing the normal range obtained using the present methods for each of the amino acids analyzed in plasma samples that were obtained from normal individuals. The age ranges of the individuals in FIG. 1A are less than 1 month and 1-2 years. The age ranges of the individuals in FIG. 1B are 1-16 years, 2-16 years, and greater than 16 years of age. The lower and upper concentration for each amino acid listed is shown as micromoles/L of plasma. 1-MHis and 3-MHis are 1-methyl histidine and 3-methyl histidine, respectively. GABA is gamma-aminobutyric acid. FIG. 2 is a table showing the normal range obtained using the present methods for each of the amino acids analyzed in cerebrospinal fluid samples that were obtained from normal individuals. The age range of the individuals is less than 1 month, 1 month-1 year, 1-18 years, and greater than 18 years of age. The lower and upper concentration for each amino acid listed is shown as micromoles/L of cerebrospinal fluid. FIGS. 3A, 3B, and 3C are tables showing the normal range obtained using the present methods for each of the amino acids analyzed in urine samples that were obtained from normal individuals. The age range of the individuals in FIG. 3A is less than 1 month, 1 month-2 years, and 2-12 years. The age range of the individuals in FIG. 3B is 12-18 years, and greater than 18 years of age. The age range of the individuals in FIG. 3C is 3-12 years, and greater than 12 years. The lower and upper concentration for each amino acid listed in FIGS. 3A and 3B are shown as micromoles/gram creatinine. The lower and upper concentration for each amino acid listed in FIG. 3C is shown as micromoles/24 hours.

The disclosed methods have been validated, showing a carryover of less than 50% of the lower limit of quantification (LLOQ) for all analytes tested, a blank matrix interference of less than 30% LLOQ for all analytes; an internal standard interference of less than 24% of the LLOQ for all analytes. All matrices tested demonstrated no response for all internal standards. The linearity of all curves was detected as being greater than r=0.9926, and for dilutional linearity, all analytes were within 15% of theoretical value following 2×, 5×, and 10× dilutions. 175 metabolites and drugs were screened for interference, and any observed interferences were chromatographically resolved. The validation data demonstrated that the methods are sensitive, accurate, and reproducible.

### Example 2

### Diagnosis of a Metabolic Disorder in a Newborn

A single plasma sample is obtained from a newborn patient for the purpose of diagnosing several metabolic disorders. The patient plasma sample is combined with labeled isotopic amino acids, and proteins are precipitated. The sample is then vigorously mixed and centrifuged to pellet the precipitated protein, and the supernatant is transferred to a well of a 96 well plate. The sample is injected onto three discreet chromatographic separations into the mass spectrometer. A triple quadrupole mass spectrometer, operating in positive ion electrospray (ESI) mode is used for detection. Measurement of analyte and internal standard are performed in selected reaction monitoring mode (SRM). The back-calculated amount of amino acids in each sample is determined from calibration curves generated by spiking known amounts of purified amino acids into blank solution at a range of 0.1 to 5000 micromoles per liter, dependent on the particular amino acid being measured. The amino acids detected in the patient sample indicate an elevation of alloisoleucine, valine, isoleucine and leucine above values considered normal for the patient's age group and sample type. These elevations indicate a metabolic disorder known as Maple Syrup Urine Disease. and this information is provided to the patient's physician and family.

While the invention has been described and illustrated with reference to certain embodiments thereof, those skilled in the art will appreciate that various changes, modifications and substitutions can be made therein without departing from the spirit and scope of the invention. All patents, published patent applications, and other non-patent references referred to herein are incorporated by reference in their entireties.

We claim:

1. A method for analyzing the presence or amount of two or more biomolecules in a sample, the method comprising:
(a) providing a sample comprising a first biomolecule and a second biomolecule;
(b1) chromatographically separating the first biomolecule from other components in the sample using a first liquid chromatography column, and (b2) chromatographically separating the second biomolecule from other components in the sample using a second liquid chromatography column; wherein the first liquid chromatography column and the second liquid chromatography column employ different column chemistries; and
(c) analyzing the chromatographically separated first biomolecule and the chromatographically separated second biomolecule by mass spectrometry to determine the presence or amount of the first biomolecule and the second biomolecule in the sample.

2. The method of claim 1, wherein the first biomolecule and the second biomolecule are amino acids.

3. The method of claim 2, wherein the amino acids independently are: 1-methylhistidine, 3-methylhistidine, α-aminoadipic acid, α-amino-n-butyric acid, alanine, alloisoleucine, α-acetyl lysine, anserine, arginine, argininosuccinic acid, asparagine, β-alanine, β-aminoisobutyric acid, aspartic acid, β-aspartylglucosamine, carnosine, citrulline, cystathionine, cysteine-homocysteine, cysteine, δ-aminolevulinic acid, ε-acetyl lysine, ethanolamine, formiminoglutamic acid, γ-amino-n-butyric acid, γ-carboxyglutamic acid, glutamic acid, glutamine, glycine, glycine-glycine, glycine-proline, hawkinsin, histidine, homocarnosine, homocitrulline, homocysteine, homoserine, hydroxylysine, hydroxy-proline, isoleucine, leucine, lysine, methionine, O-phosphoserine, ornithine, phenylalanine, phosphoethanolamine, pipecolic acid, proline, proline-hydroxyproline, pyrroline-5-carboxylate, saccharopine, S-adenosyl-homocysteine, S-adenosyl-methionine, sarcosine, serine, S-sulfo-cysteine, taurine, threonine, tryptophan, tyrosine, valine, L-DOPA, 3-nitrotyrosine, 3-iodo-tyrosine, 5-oxoproline, n-acetyl lysine, or hydroxyarginine.

4. The method of claim 1, wherein the first biomolecule and the second biomolecule are proteins.

5. The method of claim 2, wherein, prior to the chromatographically separating steps, the method comprises deproteining the sample.

6. The method of claim 1, wherein the method comprises:
(a) providing a sample comprising a first biomolecule, a second biomolecule, and a third biomolecule;
(b1) chromatographically separating the first biomolecule from other components in the sample using a first liquid chromatography column, (b2) chromatographically separating the second biomolecule from other components in the sample using a second liquid chromatography column, and (b3) chromatographically separating the third biomolecule from other components in the sample using a third liquid chromatography column; wherein the first liquid chromatography column, the second liquid chromatography column, and the third liquid chromatography column each have different column chemistries; and
(c) analyzing the chromatographically separated first biomolecule, the chromatographically separated second biomolecule, and the chromatographically separated third biomolecule by mass spectrometry to determine the presence or amount of the first biomolecule, the second biomolecule, and the third biomolecule in the sample.

7. The method of claim 6, wherein the first biomolecule, the second biomolecule, and the third biomolecule are amino acids.

8. The method of claim 7, wherein the amino acids independently are: 1-methylhistidine, 3-methylhistidine, α-aminoadipic acid, α-amino-n-butyric acid, alanine, alloisoleucine, α-acetyl lysine, anserine, arginine, argininosuccinic acid, asparagine, β-alanine, β-aminoisobutyric acid, aspartic acid, β-aspartylglucosamine, carnosine, citrulline, cystathionine, cysteine-homocysteine, cysteine, δ-aminolevulinic acid, ε-acetyl lysine, ethanolamine, formiminoglutamic acid, γ-amino-n-butyric acid, γ-carboxyglutamic acid, glutamic acid, glutamine, glycine, glycine-glycine, glycine-proline, hawkinsin, histidine, homocarnosine, homocitrulline, homocysteine, homoserine, hydroxylysine, hydroxy-proline, isoleucine, leucine, lysine, methionine, O-phosphoserine, ornithine, phenylalanine, phosphoethanolamine, pipecolic acid, proline, proline-hydroxyproline, pyrroline-5-carboxylate, saccharopine, S-adenosyl-homocysteine, S-adenosyl-methionine, sarcosine, serine, S-sulfo-cysteine, taurine, threonine, tryptophan, tyrosine, valine, L-DOPA, 3-nitrotyrosine, 3-iodo-tyrosine, 5-oxoproline, n-acetyl lysine, or hydroxyarginine.

9. The method of claim 6, wherein the first biomolecule, the second biomolecule, and the third biomolecule are proteins.

10. The method of claim 7, wherein, prior to the chromatographically separating steps, the method comprises deproteining the sample.

11. The method of claim 1, wherein one of the first liquid chromatography column and the second liquid chromatography column is a reverse phase liquid chromatography (RPLC) column and the other is a hydrophilic interactive liquid chromatography (HILIC) column.

12. The method of claim 6, wherein at least one of the first liquid chromatography column, the second liquid chromatography column, and the third liquid chromatography column is a reverse phase liquid chromatography (RPLC) column and at least one of the first liquid chromatography column, the second liquid chromatography column, and the third liquid chromatography column is a hydrophilic interactive liquid chromatography (HILIC) column.

13. The method of claim 1, wherein the chromatographically separating step of (b1) and the chromatographically separating step of (b2) are carried out during overlapping time intervals.

14. The method of claim 6, wherein the chromatographically separating step of (b1), the chromatographically separating step of (b2), and the chromatographically separating step of (b3), are carried out during overlapping time intervals.

15. The method of claim 1, wherein the first liquid chromatography column and the second liquid chromatography column are both connected inline to a single mass spectrometer.

16. The method of claim 15, wherein the mass spectrometer is a tandem mass spectrometer.

17. The method of claim 16, wherein the mass spectrometer has an atmospheric pressure ionization source.

18. The method of claim 1, wherein the analyzing step (c) includes ionizing the first biomolecule and the second biomolecule by photoionization, electrospray ionization, atmospheric pressure chemical ionization, or electron capture ionization.

19. The method of claim 18, wherein the ionizing occurs in positive ion mode.

20. The method of claim 19, wherein the ionizing method occurs in negative ion mode.

21. The method of claim 1, wherein the analyzing step (c) comprises employing multiple reaction monitoring.

22. The method of claim 1, wherein the analyzing step (c) comprises employing selected ion monitoring.

23. The method of claim 1, wherein the analyzing step (c) comprises sequentially analyzing the first biomolecule and the second biomolecule.

24. The method of claim 1, wherein the analyzing step (c) comprises simultaneously analyzing the first biomolecule and the second biomolecule.

25. A method for analyzing the amount of two or more amino acids in a sample, the method comprising:
(a) providing a sample, the sample comprising a sample that contains a first amino acid and a second amino acid;
(b) deproteinating the sample;
(c1) chromatographically separating the first amino acid from other components in the sample using a first liquid chromatography column, and (c2) chromatographically separating the second amino acid from other components in the sample using a second liquid chromatography column, wherein the first liquid chromatography column and the second liquid chromatography column employ different column chemistries; and
(d) analyzing the chromatographically separated first amino acid and the chromatographically separated second amino acid by mass spectrometry to determine the amount of the first amino acid and the second amino acid in the sample.

26. The method of claim 25, wherein the first amino acid and the second amino acid independently are: 1-methylhistidine, 3-methylhistidine, α-aminoadipic acid, α-amino-n-butyric acid, alanine, alloisoleucine, α-acetyl lysine, anserine, arginine, argininosuccinic acid, asparagine, β-alanine, β-aminoisobutyric acid, aspartic acid, β-aspartylglucosamine, carnosine, citrulline, cystathionine, cysteine-homocysteine, cysteine, δ-aminolevulinic acid, ε-acetyl lysine, ethanolamine, formiminoglutamic acid, γ-amino-n-butyric acid, γ-carboxyglutamic acid, glutamic acid, glutamine, glycine, glycine-glycine, glycine-proline, hawkinsin, histidine, homocarnosine, homocitrulline, homocysteine, homoserine, hydroxylysine, hydroxy-proline, isoleucine, leucine, lysine, methionine, O-phosphoserine, ornithine, phenylalanine, phosphoethanolamine, pipecolic acid, proline, proline-hydroxyproline, pyrroline-5-carboxylate, saccharopine, S-adenosyl-homocysteine, S-adenosyl-methionine, sarcosine, serine, S-sulfo-cysteine, taurine, threonine, tryptophan, tyrosine, valine, L-DOPA, 3-nitrotyrosine, 3-iodo-tyrosine, 5-oxoproline, n-acetyl lysine, hydroxyarginine.

27. A method generating a report for diagnosing a disease or condition associated with an abnormal level of an amino acid in a subject, the method comprising:
(a) providing a sample, the sample comprising a sample that contains a first amino acid and a second amino acid;
(b) deproteinating the sample;
(c1) chromatographically separating the first amino acid from other components in the sample using a first liquid chromatography column, and (c2) chromatographically separating the second amino acid from other components in the sample using a second liquid chromatography column, wherein the first liquid chromatography column and the second liquid chromatography column employ different column chemistries;
(d) analyzing the chromatographically separated first amino acid and the chromatographically separated second amino acid by mass spectrometry to determine the amount of the first amino acid and the second amino acid in the sample; and
(e) generating a report that recites the concentration of at least one of the first amino acid or the second amino acid in the sample.

28. The method of claim 27, wherein the first amino acid and the second amino acid independently are: 1-methylhistidine, 3-methylhistidine, α-aminoadipic acid, α-amino-n-butyric acid, alanine, alloisoleucine, α-acetyl lysine, anserine, arginine, argininosuccinic acid, asparagine, β-alanine, β-aminoisobutyric acid, aspartic acid, β-aspartylglucosamine, carnosine, citrulline, cystathionine, cysteine-homocysteine, cysteine, δ-aminolevulinic acid, ε-acetyl lysine, ethanolamine, formiminoglutamic acid, γ-amino-n-butyric acid, γ-carboxyglutamic acid, glutamic acid, glutamine, glycine, glycine-glycine, glycine-proline, hawkinsin, histidine, homocarnosine, homocitrulline, homocysteine, homoserine, hydroxylysine, hydroxy-proline, isoleucine, leucine, lysine, methionine, O-phosphoserine, ornithine, phenylalanine, phosphoethanolamine, pipecolic acid, proline, proline-hydroxyproline, pyrroline-5-carboxylate, saccharopine, S-adenosyl-homocysteine, S-adenosyl-methionine, sarcosine, serine, S-sulfo-cysteine, taurine, threonine, tryptophan, tyrosine, valine, L-DOPA, 3-nitrotyrosine, 3-iodo-tyrosine, 5-oxoproline, n-acetyl lysine, or hydroxyarginine.

29. A system for analyzing of two or more biomolecules in a sample, the system comprising:
(a) a sample, the sample comprising a first biomolecule and a second biomolecule;
(b) a station for chromatographically separating the first biomolecule from other components in the sample using a first liquid chromatography column, and for separating the second biomolecule from other components in the sample using a second liquid chromatography column, wherein the first liquid chromatography column and the second liquid chromatography column employ different column chemistries; and
(c) a station for analyzing the chromatographically separated first biomolecule and the chromatographically separated second biomolecule by mass spectrometry to determine the presence or amount of the first biomolecule and the second biomolecule in the sample.
